(19) United States
(12) Patent Application Publication
(10) Pub. No.: US 2026/0113178 A1
(43) Pub. Date: Apr. 23, 2026

(54) ENCRYPTION DEVICE INCLUDING PARAMETER OPTIMIZATION CIRCUIT, STORAGE DEVICE INCLUDING ENCRYPTION DEVICE AND METHOD OF CONFIGURING PARAMETER THEREOF

(71) Applicant: SAMSUNG ELECTRONICS CO., LTD., Suwon-si (KR)

(72) Inventor: Young Sik MOON, Suwon-si (KR)

(73) Assignee: SAMSUNG ELECTRONICS CO., LTD., Suwon-si (KR)

(21) Appl. No.: 19/302,945

(22) Filed: Aug. 18, 2025

(30) Foreign Application Priority Data
Oct. 18, 2024 (KR) 10-2024-0142551

(51) Int. Cl. H04L 9/06; H04L 9/00

(52) U.S. Cl. CPC H04L 9/0618; H04L 9/008

(57) ABSTRACT

An encryption device includes an encryption circuit encrypting a plaintext including user data and outputting an initial ciphertext, and a parameter optimization circuit generating an encryption parameter used in generating the initial ciphertext in the encryption circuit. The parameter optimization circuit receives an operation scenario from an external evaluation device and generates the encryption parameter optimized in conjunction with a bootstrapping parameter used in the external evaluation device based on the operation scenario.

### CROSS-REFERENCE TO RELATED APPLICATIONS

This application claims priority under 35 U.S.C. § 119 to Korean Patent Application No. 10-2024-0142551 filed on Oct. 18, 2024, in the Korean Intellectual Property Office, the disclosures of which are incorporated by reference herein in their entireties.

### BACKGROUND

### 1. Field

Example embodiments of the present disclosure described herein relate to a semiconductor memory device, and more particularly, relate to an encryption device including a parameter optimization circuit, a storage device including the encryption device, and a method of configuring a parameter thereof.

### 2. Description of Related Art

As communication technology develops and electronic devices become more widespread, efforts are continuously being made to maintain communication security between the electronic devices. Accordingly, encryption and decryption technologies are used in most communication environments.

When a message encrypted by encryption technology is transmitted to a counterpart, the counterpart may decrypt the encrypted message to use the message. At this time, if a third party hacks while the counterpart temporarily decrypts the message for operation, there is also a problem that the decrypted message may be easily leaked to the third party.

To solve this problem, methods of homomorphic encryption are being studied. According to the homomorphic encryption, even if encrypted information is not decrypted and operations of the encrypted information are performed on ciphertexts, the same result as values encrypted after operating preliminary texts may be obtained. Therefore, various operations may be performed without decrypting the ciphertexts.

### SUMMARY

Example embodiments of the present disclosure provide an encryption device including a parameter optimization circuit that optimizes both a parameter used in an encryption operation and a parameter used in a bootstrapping operation.

According to an example embodiment, an encryption device includes: an encryption circuit encrypting a plaintext including user data and outputting an initial ciphertext, and a parameter optimization circuit generating an encryption parameter used in generating the initial ciphertext in the encryption circuit. The parameter optimization circuit receives an operation scenario from an external evaluation device and generates the encryption parameter optimized in conjunction with a bootstrapping parameter used in the external evaluation device based on the operation scenario.

According to an example embodiment, a method of configuring a parameter for an encryption device, the method includes: receiving an operation scenario from an external evaluation device; calculating a system operation depth of the external evaluation device based on the operation scenario; determining a level of an initial ciphertext that supports the system operation depth and the number of bootstrapping operations performed by the external evaluation device; and determining a range of modular approximation polynomial operation depths of the external evaluation device based on the level of the initial ciphertext and the number of bootstrapping operations.

According to an example embodiment, a storage device includes: a memory device including a memory cell array storing user data; and a memory controller controlling the memory device to input and output the user data. The memory controller includes: an encryption circuit encrypting the user data and output an initial ciphertext; and a parameter optimization circuit determining an encryption parameter used in the encryption circuit. The parameter optimization circuit receives an operation scenario from an evaluation device of a host and generates the encryption parameter optimized in conjunction with a bootstrapping parameter used in the evaluation device based on the operation scenario.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an electronic device according to an example embodiment.

FIG. 2 is a block diagram illustrating an encryption operation system to which an encryption device of FIG. 1 is connected.

FIG. 3 is a diagram illustrating an encryption process performed in an encryption circuit of FIG. 2.

FIG. 4 is a diagram illustrating an encryption operation performed in an evaluation circuit of FIG. 2 and a bootstrapping operation performed by the bootstrapping circuit of FIG. 2 according to an example embodiment.

FIG. 5 is a table illustrating an operation scenario of FIG. 2 according to an example embodiment.

FIG. 6 is a diagram illustrating a parameter optimization circuit of FIG. 2 including a parameter mapping table.

FIG. 7 is a table illustrating an example embodiment of a parameter mapping table of FIG. 6.

FIG. 8 is a flowchart illustrating a method of determining an encryption parameter and

a bootstrapping parameter by a parameter optimization circuit of FIG. 2.

FIG. 9 is a graph with a table illustrating a relationship between the number of bootstrapping operations and time complexity based on Equation 3.

FIG. 10 is a graph illustrating a range (or a parameter pool) of modular approximation polynomial operation depth determined based on Equation 8.

FIG. 11 is a block diagram illustrating a user device according to an example embodiment.

FIG. 12 is a block diagram illustrating a memory controller of FIG. 11 according to an example embodiment.

### DETAILED DESCRIPTION

Below, example embodiments of the present disclosure will be described in detail and clearly to such an extent that an ordinary one in the art easily implements the inventive concepts.

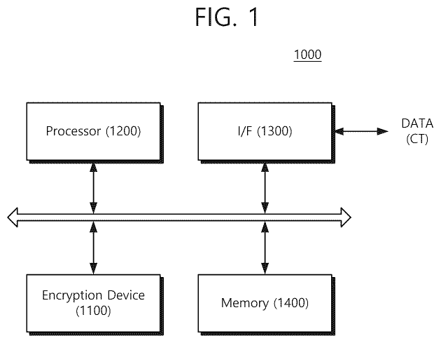

FIG. 1 is a block diagram illustrating an electronic device according to an example embodiment. Referring to FIG. 1, an electronic device 1000 may include an encryption device 1100, a processor 1200, an interface 1300 and/or a memory 1400. The electronic device 1000 may transmit and receive data DATA with an external device. The data DATA may be transmitted in a form of an initial ciphertext CT.

The electronic device 1000 may be implemented as various electronic devices or included in various electronic devices. For example, the electronic device 1000 may include a drone, a robot device such as an Advanced Drivers Assistance System (ADAS), a smart TV, a smart phone, a medical device, a mobile device, a video display device, a measuring device, an Internet of Things (IoT) device, or the like.

The encryption device 1100 may encrypt and/or decrypt data DATA received from outside the electronic device 1000 or data DATA generated inside the electronic device 1000. The encryption device 1100 may maintain security of data DATA by performing an encryption operation based on an encryption algorithm. The encryption algorithm may be, for example, an algorithm that generates encrypted data using an encryption key. As an example, the encryption algorithm may include a homomorphic encryption algorithm.

The processor 1200 may transmit and receive data DATA to and from the outside of the electronic device 1000 through the interface 1300. The processor 1200 may execute a task and store a result of the task in the memory 1400 (for example, a buffer memory). As an example, the processor 1200 may include a plurality of cores.

The memory 1400 may store various data required for operations of the processor 1200. For example, the memory 1400 may be implemented as a dynamic random access memory (DRAM), a mobile DRAM, a static RAM (SRAM), a phase change RAM (PRAM), a ferroelectric RAM (FRAM), a resistive RAM and/or a magnetic RAM (MRAM).

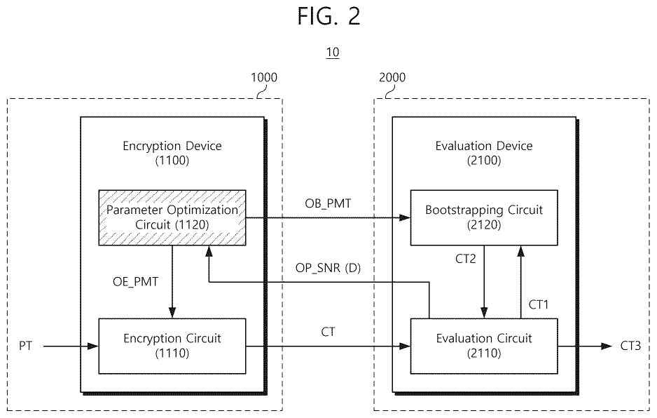

FIG. 2 is a block diagram illustrating an encryption operation system to which an encryption device of FIG. 1 is connected or of which an encryption device of FIG. 1 is a part. Referring to FIGS. 1 and 2, the encryption operation system 10 may include an electronic device 1000 including an encryption device 1100 and/or another electronic device 2000 including an evaluation device 2100. As an example, another electronic device 2000 may include a server.

The encryption device 1100 may include an encryption circuit 1110. For example, the encryption circuit 1110 may generate an initial ciphertext CT by encrypting a plaintext PT according to a homomorphic encryption technique. The encryption device 1100 may generate the initial ciphertext CT based on an encryption parameter OE_PMT. As an example, the encryption parameter OE_PMT may include a level of the initial ciphertext CT.

The evaluation device 2100 may include an evaluation circuit 2110. For example, the evaluation circuit 2110 may receive a plurality of initial ciphertexts CT from the encryption circuit 1110. The evaluation circuit 2110 may perform at least one operation on the plurality of initial ciphertexts CT without decryption operations. An initial ciphertext CT may include a preliminary text, a message and an error based on the homomorphic encryption technique. The message may be a valid bit that does not include an error. Each time a multiplication operation is performed on an initial ciphertext CT, a length of the preliminary text may decrease and a length of the error may increase.

The bootstrapping circuit 2120 may perform a bootstrapping operation to reduce the length of the error for the ciphertext whose length of error has increased. For example, the evaluation circuit 2110 may transmit a first ciphertext CT1 whose length of error has increased to the bootstrapping circuit 2120. The bootstrapping circuit 2120 may transmit a second ciphertext CT2 whose length of error has been reduced from the first ciphertext CT1 back to the evaluation circuit 2110. The evaluation circuit 2110 may perform at least one operation based on the second ciphertext CT2 and finally output a third ciphertext CT3.

The bootstrapping circuit 2120 may perform at least one bootstrapping operation on the first ciphertext CT1 based on a bootstrapping parameter OB_PMT. For example, the bootstrapping parameter OB_PMT may include the number of bootstrapping operations.

A parameter optimization circuit 1120 may simultaneously optimize the encryption operation of the encryption circuit 1110 and the bootstrapping operation of the bootstrapping circuit 2120 by generating the encryption parameter OE_PMT and the bootstrapping parameter OB_PMT. For example, the parameter optimization circuit 1120 may receive an operation scenario OP_SNR from the evaluation circuit 2110. The parameter optimization circuit 1120 may generate the encryption parameter OE_PMT and the bootstrapping parameter OB_PMT based on the operation scenario OP_SNR. As an example, the operation scenario OP_SNR may include a system operation depth (D). The system operation depth (D) may mean a size of paths of operations that a plurality of initial ciphertexts CT pass through in the evaluation circuit 2110.

The parameter optimization circuit 1120 may convert operational complexity with respect to a homomorphic encryption operation system of the evaluation circuit 2110 into time complexity based on the system operation depth (D). For example, the operational complexity (or system complexity) of the evaluation circuit 2110 may be expressed such as Equation 1.

$$System complexity D \leq L + a {L}_{boot} \qquad [ Equation 1 ]$$

In Equation 1, “D” means a system operation depth. “L” means a level of an initial ciphertext. “a” means the number of bootstrapping operations. “L_{boot}” means a remaining level of a ciphertext after the bootstrapping operations. Referring to Equation 1, the maximum value of the system operation depth (D) is expressed as the sum of the level (L) of the initial ciphertext CT and the residual levels (aL_{boot}) of the first ciphertext CT1 after the bootstrapping operations is performed. The parameter optimization circuit 1120 may convert the operational complexity (or system complexity) of Equation 1 into time complexity as in Equation 2.

$$Time complexity = {\sum }_{l = 1}^{L} {t}_{l} + a {t}_{boot} + a {\sum }_{l = 1}^{{L}_{b o o t}} {t}_{l} \qquad [ Equation 2 ]$$

In Equation 2 of an equation for the time complexity, “tₗ” means a time being consumed for executing each operation included in the operation scenario OP_SNR (or a time being consumed for a multiplication operation between ciphertexts at level l). “a” means the number of bootstrapping operations. “t_{boot}” means a time for each bootstrapping operation. “t_{boot}” may be inversely proportional to “L_{boot}.” The more complex the bootstrapping algorithm, the longer the bootstrapping operation time may be required.

The parameter optimization circuit 1120 may determine the level (L) of the initial ciphertext CT and the number of bootstrapping operations (a) that minimize Equation 2. For example, the parameter optimization circuit 1120 may calculate the level (L) of the initial ciphertext CT and the number of bootstrapping operations (a) that are satisfied with Equation 3.

$$Find L , a to mimimize {\sum }_{l = 1}^{L} {t}_{l} + a ( {t}_{boot} + {\sum }_{l = 1}^{{L}_{b o o t}} {t}_{l} ) \qquad [ Equation 3 ]$$

$$subject to D \leq L + a {L}_{boot}$$

“L_{boot}” may mean a remaining level after subtracting a level consumed in a bootstrapping operation from the level (L) of the initial ciphertext CT. In a process of a bootstrapping operation in the bootstrapping circuit 2120, an operation depth as much as “L-L_{boot}” may be consumed. Since a time of the multiplication operation between ciphertexts at level l is “tₗ”, an operation time according to consumption of the operation depth in the process of the bootstrapping operation may be

$$“ {Σ}_{l = 1 + {L}_{b o o t}}^{L} {t}_{l} ” .$$

If other operation time required in addition to the time consumed by the operation depth is defined as an arbitrary constant value (for example, “Const.”), the time consumed by the bootstrapping operation in the bootstrapping circuit 2120 may be simplified as illustrated in Equation 4.

$${t}_{boot} = {\sum }_{l = {L}_{b o o t} + 1}^{L} {t}_{l} + Const . \qquad [ Equation 4 ]$$

By substituting Equation 4 into Equation 3 and organizing, Equation 3 may be simplified as Equation 5.

$${\sum }_{l = 1}^{L} {t}_{l} + a ( Const . + {\sum }_{l = {L}_{b o o t} + 1}^{L} {t}_{l} + {\sum }_{l = 1}^{{L}_{b o o t}} {t}_{l} ) = {\sum }_{l = 1}^{L} {t}_{l} + a ( Const . + {\sum }_{l = 1}^{L} {t}_{l} ) = ( a + 1 ) {\sum }_{l = 1}^{L} {t}_{l} + aConst . \qquad [ Equation 5 ]$$

The parameter optimization circuit 1120 may set “L_{boot}” as in Equation 6.

$${L}_{boot} = L - k - d \qquad [ Equation 6 ]$$

In Equation 6, “d” means an operation depth (for example, a modular approximation polynomial operation depth (d)) consumed in a modular approximation polynomial operation in a bootstrapping operation. “k” means a remaining operation depth required in the bootstrapping operation with the exception of “d”. The parameter optimization circuit 1120 may calculate the level (L) of the initial ciphertext CT and the number of bootstrapping operations (a) according to Equation 7 based on Equation 3, Equation 5 and Equation 6.

$$Find L , a to minimize ( a + 1 ) {\sum }_{l = 1}^{L} {t}_{l} + aConst . subject to a \geq \frac{D - L}{( L - k - d )} \qquad [ Equation 7 ]$$

The parameter optimization circuit 1120 may determine or calculate the level (L) of the initial ciphertext CT and the number of bootstrapping operations (a) that minimize a value of Equation 7. The parameter optimization circuit 1120 may search a modular approximation polynomial operation depth (d) that may achieve accuracy required by the evaluation circuit 2110 based on the level (L) of the initial ciphertext CT and the number of bootstrapping operations (a) that are determined to minimize a value of Equation 7. A range of the modular approximation polynomial operation depth (d) may be expressed as Equation 8.

$$\frac{( L - k ) ( a - 1 ) + L - D}{a - 1} < d \leq \frac{( L - k ) a + L - D}{a} \qquad [ Equation 8 ]$$

A right-hand side of Equation 8 means the maximum value of the modular approximation polynomial operation depth (d) at the determined number of bootstrapping operations (a). The left-hand side of Equation 8 may mean the modular approximation polynomial operation depth (d) when the number of bootstrapping operations is assumed to be one less than the determined number of bootstrapping operations (a). When the modular approximation polynomial operation depth (d) may become larger than the left-hand side of Equation 8, the level (L) of the initial ciphertext CT and the number of bootstrapping operations (a) may optimize an operation process of the evaluation circuit 2110.

The encryption parameter OE_PMT may include the level (L) of the initial ciphertext CT determined by the parameter optimization circuit 1120. The bootstrapping parameter OB_PMT may include the level (L) of the initial ciphertext CT and the number of bootstrapping operations (a) determined by the parameter optimization circuit 1120.

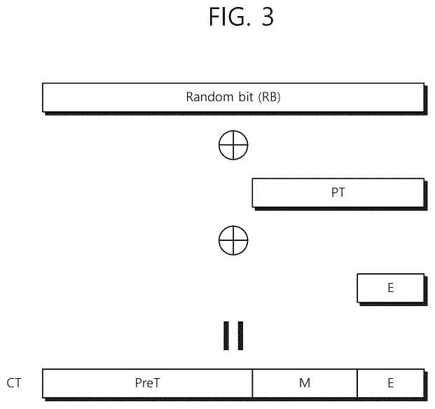

FIG. 3 is a diagram illustrating an encryption process performed in an encryption circuit of FIG. 2. Referring to FIGS. 2 and 3, the encryption circuit 1110 may encrypt a plaintext PT and output an initial ciphertext CT.

The encryption circuit 1110 may receive the encryption parameter OE_PMT from the parameter optimization circuit 1120. The encryption parameter OE_PMT may include information corresponding to a level (L) of the initial ciphertext CT. The encryption circuit 1110 may receive the plaintext PT. As an example, the plaintext PT may include information related to the electronic device 1000 or a user of the electronic device 1000 (for example, personal information of the user).

The encryption circuit 1110 may generate the initial ciphertext CT by combining random bits RB, the plaintext PT and an error E based on the encryption parameter OE_PMT. The initial ciphertext CT may include a preliminary text PreT, a message M and the error E. In the initial ciphertext CT, the error E may be set to be smaller than the message M, and the message M may be set to be smaller than the preliminary text PreT.

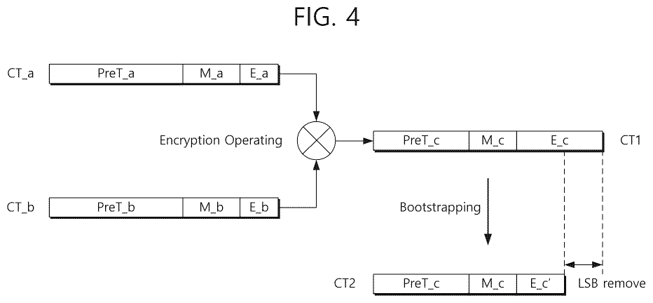

FIG. 4 is a diagram illustrating an encryption operation performed in an evaluation circuit of FIG. 2 and a bootstrapping operation performed by the bootstrapping circuit of FIG. 2 according to an example embodiment. Referring to FIGS. 2 and 4, the evaluation circuit 2110 may receive a first initial ciphertext CT_a and a second initial ciphertext CT_b from the encryption circuit 1110. However, this is exemplary, and the evaluation circuit 2110 may receive a plurality of initial ciphertexts CT from the encryption circuit 1110.

The evaluation circuit 2110 may perform an encrypting operation on the first initial ciphertext CT_a and the second initial ciphertext CT_b to generate a first ciphertext CT1. However, this is exemplary, and the evaluation circuit 2110 may perform multiple encrypting operations to generate the first ciphertext CT1. In the first ciphertext CT1 compared to the initial ciphertexts CT_a and CT_b, a size of a preliminary text and a size of a message may reduce and a size of an error may increase. In the first ciphertext CT1, an error E_c has increased to the maximum and an encrypting operation may no longer be performed on the first ciphertext CT1.

The bootstrapping circuit 2120 may perform a bootstrapping operation on the first ciphertext CT1 that may no longer perform an encrypting operation. The bootstrapping circuit 2120 may reduce the error E_c of the first ciphertext CT1 by removing least significant bits LSB of the first ciphertext CT1 through the bootstrapping operation. The bootstrapping circuit 2120 may transmit the second ciphertext CT2 with a reduced error E_c′ to the evaluation circuit 2110. At this time, the bootstrapping circuit 2120 may perform the bootstrapping operation based on the bootstrapping parameter OB_PMT determined by the parameter optimization circuit 1120.

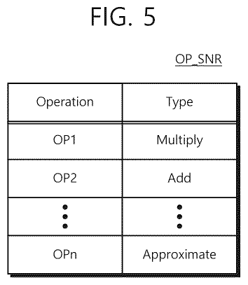

FIG. 5 is a table illustrating an operation scenario of FIG. 2 according to an example embodiment. Referring to FIGS. 2 and 5, an operation scenario OP_SNR may include a plurality of operations OP1 to OPn. Each of the plurality of operations OP1 to OPn may be one of an addition operation, a multiplication operation and/or an approximation operation. For example, the multiplication operation may increase an error included in the ciphertext, like an encrypting operation of FIG. 4. The approximation operation may include at least one of the addition operation and/or the multiplication operation.

The parameter optimization circuit 1120 may receive the operation scenario OP_SNR from the evaluation circuit 2110. The parameter optimization circuit 1120 may check encrypting operations included in the operation scenario OP_SNR and calculate the system operation depth (D). The parameter optimization circuit 1120 may determine the encryption parameter OE_PMT and the bootstrapping parameter OB_PMT by linking them based on the system operation depth (D).

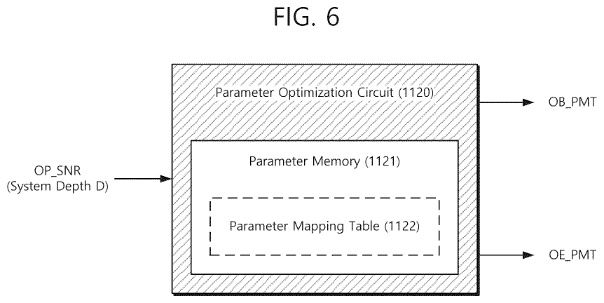

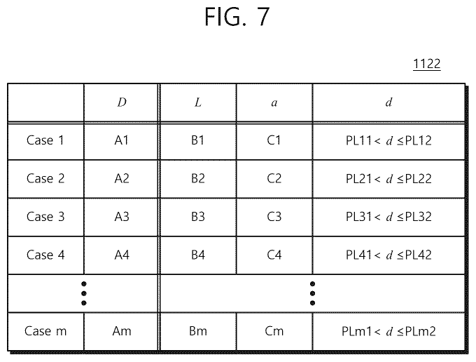

FIG. 6 is a diagram illustrating a parameter optimization circuit of FIG. 2 including a parameter mapping table. FIG. 7 is a table illustrating an example embodiment of a parameter mapping table of FIG. 6. Referring to FIGS. 6 and 7, the parameter optimization circuit 1120 may include a parameter memory 1121. The parameter memory 1121 may store a parameter mapping table 1122.

The parameter optimization circuit 1120 may determine the encryption parameter OE_PMT and the bootstrapping parameter OB_PMT based on the parameter mapping table 1122. For example, the parameter optimization circuit 1120 may store a parameter mapping table 1122 calculated in advance based on Equations 1 to 8.

The parameter optimization circuit 1120 may receive an operation scenario OP_SNR from the evaluation circuit 2110. The parameter optimization circuit 1120 may confirm encrypting operations included in the operation scenario OP_SNR and calculate a system operation depth (D).

The parameter optimization circuit 1120 may determine a level (L) of an initial ciphertext CT and the number of bootstrapping operations (a) corresponding to the calculated system operation depth (D) based on the parameter mapping table 1122. For example, in a first case (Case 1), when a system operation depth (D) is calculated as A1, a level (L) of an initial ciphertext CT and the number of bootstrapping operations (a) may be determined as B1 and C1. Likewise, in second to m-th cases (Case 2 to Case m), when system operation depths (D) are calculated as A2 to Am, respectively, levels (L) of initial ciphertexts CT and the numbers of bootstrapping operations (a) may be determined by the parameter mapping table 1122.

The parameter optimization circuit 1120 may confirm a range (or a parameter pool) of a modular approximation polynomial operation depth (d) corresponding to the levels (L) of the initial ciphertexts CT and the numbers of bootstrapping operations (a) determined based on the parameter mapping table 1122. For example, in the first case (Case 1), a range (for example, PL11<d≤PL12) of a modular approximation polynomial operation depth (d) corresponding to B1 and C1 may be confirmed.

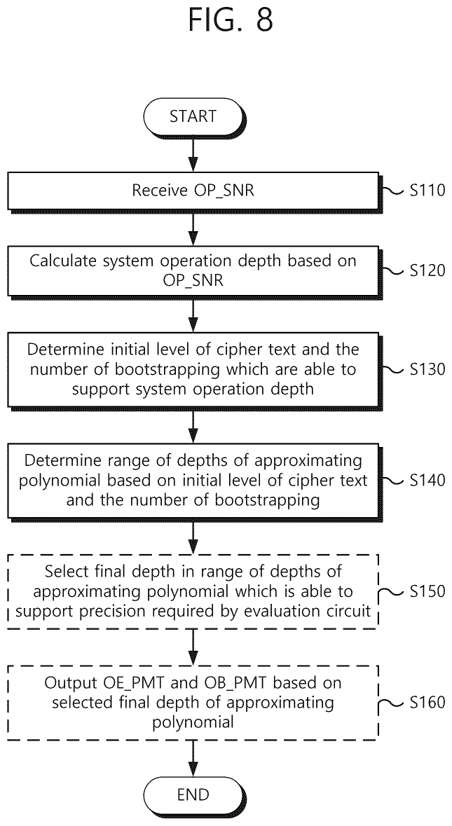

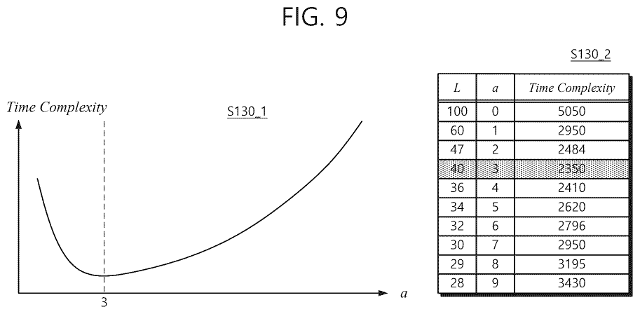

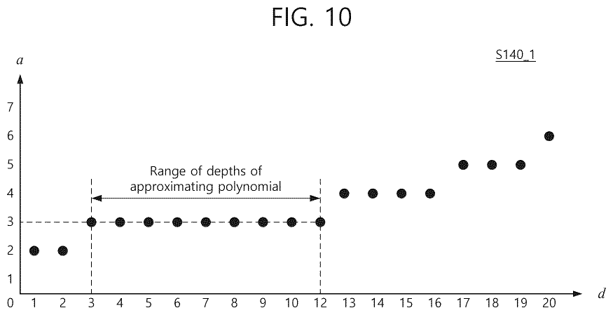

FIG. 8 is a flowchart illustrating a method of determining an encryption parameter and a bootstrapping parameter by a parameter optimization circuit of FIG. 2. FIG. 9 is a graph with a table illustrating a relationship between the number of bootstrapping operations and time complexity based on Equation 3. FIG. 10 is a graph illustrating a range (or a parameter pool) of modular approximate polynomial operation depth determined based on Equation 8. Referring to FIGS. 2 and 8, the parameter optimization circuit 1120 may generate an encryption parameter OE_PMT and a bootstrapping parameter OB_PMT that optimize encryption operations and bootstrapping operations by linking them based on an operation scenario OP_SNR.

In operation S110, the parameter optimization circuit 1120 (or the encryption device 1100) may receive the operation scenario OP_SNR. For example, the parameter optimization circuit 1120 may receive the operation scenario OP_SNR from the evaluation circuit 2110 included in the evaluation device 2100.

In operation S120, the parameter optimization circuit 1120 (or the encryption device 1100) may calculate a system operation depth (D) based on the operation scenario OP_SNR. For example, the operation scenario OP_SNR may include information corresponding to operations performed in the evaluation circuit 2110 as illustrated in FIG. 5. As an example, the parameter optimization circuit 1120 may calculate the number of multiplication operations and/or approximation operations in the operation scenario OP_SNR as the system operation depth (D).

In operation S130, the parameter optimization circuit 1120 (or the encryption device 1100) may determine a level (L) of an initial ciphertext CT and the number of bootstrapping operations (a) that may support the system operation depth (D). As an example, the parameter optimization circuit 1120 may obtain the level (L) of the initial ciphertext CT and the number of bootstrapping operations (a) by applying the system operation depth (D) to Equations 1 to 3.

As another example, the parameter optimization circuit 1120 may store the parameter mapping table 1122 such as FIG. 7, which is generated based on Equations 1 to 7. The parameter optimization circuit 1120 may obtain the level (L) of the initial ciphertext CT and the number of bootstrapping operations (a) corresponding to the system operation depth (D) based on the parameter mapping table 1122.

For example, referring to FIG. 9, the parameter optimization circuit 1120 may obtain a relationship graph S130_1 between the number of bootstrapping operations (a) and time complexity based on Equation 3. The parameter optimization circuit 1120 may obtain a correspondence table S130_2 with respect to the level (L) of the initial ciphertext CT and the number of bootstrapping operations (a) based on Equation 3. The parameter optimization circuit 1120 may confirm that the time complexity is the lowest when the number of bootstrapping operations (a) is 3 based on the graph S130_1, and confirm the level (L) (for example, 40) of the initial ciphertext CT when the number of bootstrapping operations (a) is 3 in the correspondence table S130_2.

In operation S140, the parameter optimization circuit 1120 (or the encryption device 1100) may determine a range (or a parameter pool) of modular approximation polynomial operation depths (d) based on the determined level (L) of the initial ciphertext CT and the number of bootstrapping operations (a). As an example, the parameter optimization circuit 1120 may obtain the range of modular approximation polynomial operation depths (d) by applying the level (L) of the initial ciphertext CT and the number of bootstrapping operations (a) to Equation 8. Depending on precision required in the evaluation circuit 2110, multiple modular approximation polynomial operation depths (d) may be included in the optimal value.

As another example, the parameter optimization circuit 1120 may store the range of modular approximation polynomial operation depths (d) in the parameter mapping table 1122 as illustrated in FIG. 7 based on Equation 8. The parameter optimization circuit 1120 may obtain the range of modular approximation polynomial operation depths (d) corresponding to the level (L) of the initial ciphertext CT and the number of bootstrapping operations (a) based on the parameter mapping table 1122.

For example, referring to FIG. 10, the parameter optimization circuit 1120 may obtain a graph S140_1 illustrating modular approximation polynomial operation depths (d) corresponding to the level (L) of the initial ciphertext CT and the number of bootstrapping operations (a) based on Equation 8. In the graph S140_1, the parameter optimization circuit 1120 may obtain a range of optimal modular approximation polynomial operation depths (d) when the number of bootstrapping operations (a) is 3.

In operation S150, the parameter optimization circuit 1120 (or the encryption device 1100) may select a final modular approximation polynomial operation depth (d) that may support precision required by the evaluation circuit 2110 from the range of optimal modular approximation polynomial operation depths (d). As an example, operation S150 may be selectively performed based on various existing optimal value selection methods.

In operation S160, the parameter optimization circuit 1120 (or the encryption device 1100) may output an encryption parameter OE_PMT and a bootstrapping parameter OB_PMT based on the selected final modular approximation polynomial operation depth (d). The parameter optimization circuit 1120 may transmit the encryption parameter OE_PMT to the encryption circuit 1110. The parameter optimization circuit 1120 may transmit the bootstrapping parameter OB_PMT to the bootstrapping circuit 2120. As the encryption parameter OE_PMT and the bootstrapping parameter OB_PMT are values set in accordance with the system operation depth (D) of the evaluation circuit 2110, the evaluation circuit 2110 may perform optimal encrypting operations based on ciphertexts received from the encryption circuit 1110 and/or the bootstrapping circuit 2120.

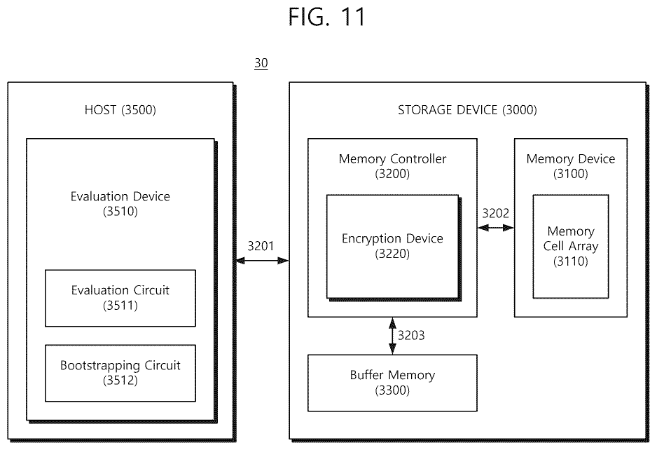

FIG. 11 is a block diagram illustrating a user device according to an example embodiment. Referring to FIG. 11, the user device 30 may include a storage device 3000 and a host 3500. The storage device 3000 and the host 3500 may be connected through a host interface 3201. The host interface 3201 may be a standard interface such as ATA, SATA, PATA, USB, SCSI, ESDI, IEEE 1394, IDE and/or card interface, or the like.

The storage device 3000 may be a storage device based on a non-volatile memory. For example, the storage device 3000 may include a memory device 3100, a memory controller 3200, and a buffer memory 3300. The memory device 3100 may be a non-volatile memory such as a flash memory or phase change memory (PRAM). When the memory device 3100 is a flash memory, the storage device 3000 may be a flash storage device based on the flash memory. For example, the storage device 3000 may be an SSD, UFS, and/or memory card, or the like. The buffer memory 3300 may include volatile memory (for example, DRAM).

The memory device 3100 may be connected to the memory controller 3200 through a memory interface 3202. The memory device 3100 may include a memory cell array and a peripheral circuit. The peripheral circuitry may include all analog or digital circuits required to store or read data in the memory cell array.

The peripheral circuit may receive external power from the memory controller 3200 and generate various levels of internal power. The peripheral circuit may receive commands, addresses and data from the memory controller 3200, and store the data in the memory cell array according to the control signals. Additionally, the peripheral circuit may read data stored in the memory cell array and provide the data to the memory controller 3200.

The memory cell array may include a plurality of memory blocks. Each memory block may have a vertical three-dimensional structure. Each memory block may include a plurality of memory cells. Multi-bit data may be stored in each memory cell. For example, the memory device 3100 may be a TLC flash memory capable of storing 3 bits of data in one memory cell.

The memory cell array 3110 may be located next to or above the peripheral circuit due to the design arrangement structure. The structure in which the memory cell array 3110 is located above the peripheral circuit is called a COP (cell on peripheral) structure. The memory cell array 3110 may be manufactured as a separate chip from the peripheral circuit. The upper chip including the memory cell array 3110 and the lower chip including the peripheral circuit may be connected to each other using a bonding method. This structure is called C2C (chip to chip) structure.

The memory controller 3200 may be connected between the memory device 3100 and the host 3500. Additionally, the memory controller 3200 may be connected between the buffer memory 3300 and the host 3500. The memory controller 3200 may control read or write operations of the memory device 3100 and/or the buffer memory 3300 in response to a request from the host 3500. The memory controller 3200 may receive host data from the host 3500 and provide the host data to the memory device 3100 and/or the buffer memory 3300.

The memory controller 3200 may include a control unit and a work memory. The control unit may control overall operations of the memory controller 3200. For example, the control unit may control a flash translation layer (FTL) to perform an address mapping operation. The control unit may be a commercially available or custom microprocessor.

The work memory may be cache memory (for example, a SRAM). The work memory may serve as a buffer memory 3300 that temporarily stores data. Additionally, the work memory may be a driving memory of the memory controller 3200. The work memory may drive the FTL.

The buffer memory 3300 may be connected to the memory controller 3200 through a buffer interface 3203. For example, the buffer memory 3300 may be used to temporarily store data to be stored in or read from the memory device 3100. Additionally, a cache area capable of storing cache data may be allocated to the buffer memory 3300. The buffer memory 3300 may be implemented with a DRAM and a SRAM, or the like. The buffer memory 3300 may be included in the memory device 3100 or the memory controller 3200.

The host 3500 may include a processor and a host memory. The processor and the host memory may be connected via an address/data bus. The host 3500 may be a personal digital assistance (PDA), a computer, a digital audio player, a digital camera and/or a mobile phone, or the like. The host memory may be a non-volatile or volatile memory in the form of a cache, a ROM, a PROM, an EPROM, an EEPROM, a flash, a SRAM, a DRAM, or the like.

The host memory may drive a plurality of software or firmware. For example, the host memory may drive an operating system (OS), applications, a file system, a memory manager, and I/O drivers, or the like.

The memory controller 3200 may include an encryption device 3220. The encryption device 3220 may include the same or similar configuration and characteristics as the encryption device 1100 of FIG. 2. The encryption device 3220 may encrypt user data stored in the memory cell array 3110. When receiving a request for user data stored in the memory cell array 3110 from the host 3500, the storage device 3000 may transmit ciphertexts, encrypted by the encryption device 3220, corresponding to the user data to the host 3500.

The host 3500 may include an evaluation device 3510. The evaluation device 3510 may include the same or similar configuration and characteristics as the evaluation device 2100 of FIG. 2. The evaluation device 3510 may include an evaluation circuit 3511 and/or a bootstrapping circuit 3512. The evaluation circuit 3511 and the bootstrapping circuit 3512 may include the same or similar configuration and characteristics as the evaluation circuit 2110 and the bootstrapping circuit 2120 of FIG. 2.

The encryption device 3220 may receive an operation scenario from the evaluation circuit 3511. Based on the operation scenario, the encryption device 3220 may calculate a system operation depth of the evaluation circuit 3511. The encryption device 3220 may generate parameters to be used in the encryption device 3220 and the bootstrapping circuit 2120 so that the encryption device 3220 and the bootstrapping circuit 2120 may be optimized in conjunction with each other based on the system operation depth of the evaluation circuit 3511.

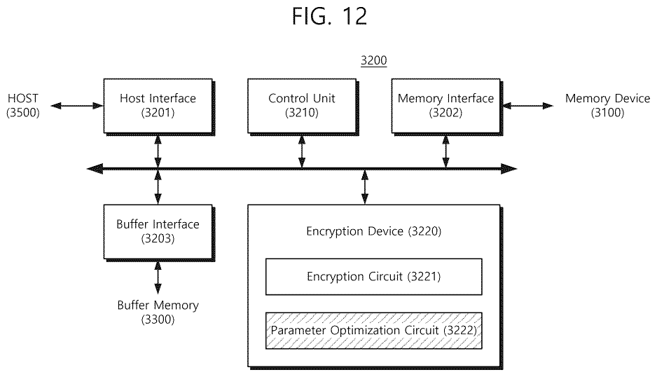

FIG. 12 is a block diagram illustrating a memory controller of FIG. 11 according to an example embodiment. Referring to FIG. 12, the memory controller 3200 may include a host interface 3201, a memory interface 3202, a buffer interface 3203, a control unit 3210 and a work memory 3220.

Although not illustrated in FIG. 12, the memory controller 3200 may further include various other components. For example, the memory controller 3200 may further include an ECC circuit, a command generation module, or the like. The ECC circuit may generate an error correction code (ECC) to correct fail bits or error bits of data received from the memory device 3100. The command generation module may generate a command CMD for controlling memory operations according to a request from the host 3500.

The host interface 3201 may provide an interface between the host 3500 and the memory controller 3200. Standard interfaces include various interface methods such as an advanced technology attachment (ATA), a serial ATA (SATA), an external SATA (e-SATA), a small computer small interface (SCSI), a serial attached SCSI (SAS), a peripheral component interconnection (PCI), a PCI express (PCI-E), an IEEE 1394, an universal serial bus (USB), a secure digital (SD) card, a multimedia card (MMC), an embedded multimedia card (eMMC), universal flash storage (UFS), a compact flash (CF) card interface, or the like.

The memory interface 3202 may provide an interface between the memory device 3100 and the memory controller 3200. For example, write or read data may be transmitted to and received from the memory device 3100 through the memory interface 3202. The memory interface 3202 may provide commands and addresses to the memory device 3100. Additionally, the memory interface 3202 may provide data read from the memory device 3100 to the memory controller 3200.

The buffer interface 3203 may provide an interface between the buffer memory 3300 and the memory controller 3200. For example, data temporarily stored in the buffer memory 3300 may be transmitted to and received from the buffer memory 3300 through the buffer interface 3203.

The control unit 3210 may include a central processing unit, a microprocessor, or the like, and may control the overall operation of the memory controller 3200. The control unit 3210 may drive firmware loaded in the work memory 3220 to control the memory controller 3200.

The encryption device 3220 may include an encryption circuit 3221 and/or a parameter optimization circuit 3222. The encryption circuit 3221 and the parameter optimization circuit 3222 may include the same or similar configuration and characteristics as the encryption circuit 1110 and the parameter optimization circuit 1120 of FIG. 2.

The encryption circuit 3221 may encrypt user data stored in the memory cell array 3110. When receiving a request for user data stored in the memory cell array 3110 from the host 3500, the encryption circuit 3221 may transmit ciphertexts corresponding to the requested user data to the host 3500.

The parameter optimization circuit 3222 may receive an operation scenario from the evaluation circuit 3511. Based on the operation scenario, the parameter optimization circuit 3222 may calculate the system operation depth of the evaluation circuit 3511. As described in FIGS. 2 to 10, the parameter optimization circuit 3222 may generate parameters (for example, encryption parameters OE_PMT and bootstrapping parameters OB_PMT) to be used in the encryption device 3220 and the bootstrapping circuit 2120 so that the encryption device 3220 and the bootstrapping circuit 2120 are optimized in conjunction with each other based on the system operation depth of the evaluation circuit 3511.

According to the present disclosure, it may be possible to simultaneously optimize an encryption operation of an encryption device and a bootstrapping operation of an evaluation device in conjunction with each other.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An encryption device comprising:
an encryption circuit configured to encrypt a plaintext including user data and output an initial ciphertext; and
a parameter optimization circuit configured to receive an operation scenario from an external evaluation device, and generate an encryption parameter for use in generating the initial ciphertext in the encryption circuit and a bootstrapping parameter for use in the external evaluation device,
wherein the parameter optimization circuit generates the encryption parameter optimized in conjunction with the bootstrapping parameter based on the operation scenario.

2. The encryption device of claim 1, wherein the parameter optimization circuit is configured to calculate a system operation depth of the external evaluation device based on the operation scenario.

3. The encryption device of claim 2, wherein the parameter optimization circuit is configured to:
convert a system complexity equation of the external evaluation device into a time complexity equation, and
apply the system operation depth to the time complexity equation to determine a level of the initial ciphertext and the number of bootstrapping operations of a bootstrapping circuit included in the external evaluation device.

4. The encryption device of claim 3, wherein the parameter optimization circuit is configured to:
apply the level of the initial ciphertext and the number of bootstrapping operations to the time complexity equation, and
determine a range of modular approximation polynomial operation depths of the external evaluation device based on accuracy required by the external evaluation device.

5. The encryption device of claim 4, wherein the parameter optimization circuit is configured to determine a final modular approximation polynomial operation depth that meets the accuracy required by the external evaluation device among the range of modular approximation polynomial operation depths.

6. The encryption device of claim 5, wherein the parameter optimization circuit is configured to output the encryption parameter and the bootstrapping parameter in conjunction with each other based on the final modular approximation polynomial operation depth.

7. The encryption device of claim 3, wherein the parameter optimization circuit is configured to:
store a parameter mapping table generated in advance based on the time complexity equation, and
determine the level of the initial ciphertext and the number of bootstrapping operations corresponding to the system operation depth.

8. The encryption device of claim 7, wherein the parameter optimization circuit is configured to determine a range of modular approximation polynomial operation depths of the external evaluation device corresponding to the level of the initial ciphertext and the number of bootstrapping operations based on the parameter mapping table.

9. A method of configuring a parameter for an encryption device, the method comprising:
receiving an operation scenario from an external evaluation device;
calculating a system operation depth of the external evaluation device based on the operation scenario;
determining a level of an initial ciphertext that supports the system operation depth and the number of bootstrapping operations performed by the external evaluation device; and
determining a range of modular approximation polynomial operation depths of the external evaluation device based on the level of the initial ciphertext and the number of bootstrapping operations.

10. The method of claim 9, wherein the calculating the system operation depth comprises determining the system operation depth based on the number of addition operations and approximation operations included in the operation scenario.

11. The method of claim 10, wherein the determining the level of the initial ciphertext and the number of bootstrapping operations comprises:
converting a system complexity equation of the external evaluation device into a time complexity equation; and
determining the level of the initial ciphertext and the number of bootstrapping operations by applying the system operation depth to the time complexity equation.

12. The method of claim 11, wherein the determining the range of the modular approximation polynomial operation depths comprises:
applying the level of the initial ciphertext and the number of bootstrapping operations to the time complexity equation, and
determining the range of modular approximation polynomial operation depths of the external evaluation device based on accuracy required by the external evaluation device.

13. The method of claim 9, further comprising:
determining a final modular approximation polynomial operation depth that meets an accuracy required by the external evaluation device among the range of modular approximation polynomial operation depths.

14. The method of claim 13, further comprising:
outputting an encryption parameter in conjunction with a bootstrapping parameter used in the external evaluation device based on the final modular approximation polynomial operation depth.

15. The method of claim 11, wherein the determining the level of the initial ciphertext and the number of bootstrapping operations comprises:
storing a parameter mapping table generated in advance based on the time complexity equation, and
determining the level of the initial ciphertext and the number of bootstrapping operations based on the parameter mapping table.

16. A storage device comprising:
a memory device including a memory cell array storing user data; and
a memory controller configured to control the memory device to input and output the user data,
wherein the memory controller comprises:
an encryption circuit configured to encrypt the user data and output an initial ciphertext; and
a parameter optimization circuit configured to determine an encryption parameter used in the encryption circuit, and
wherein the parameter optimization circuit is configured to receive an operation scenario from an evaluation device of a host and generate the encryption parameter optimized in conjunction with a bootstrapping parameter used in the evaluation device based on the operation scenario.

17. The storage device of claim 16, wherein the parameter optimization circuit is configured to calculate a system operation depth of the evaluation device based on the operation scenario.

18. The storage device of claim 17, wherein the parameter optimization circuit is configured to:
convert a system complexity equation of the evaluation device into a time complexity equation, and
apply the system operation depth to the time complexity equation to determine a level of the initial ciphertext and the number of bootstrapping operations of a bootstrapping circuit included in the evaluation device.

19. The storage device of claim 18, wherein the parameter optimization circuit is configured to:
apply the level of the initial ciphertext and the number of bootstrapping operations to the time complexity equation, and
determine a range of modular approximation polynomial operation depths of the evaluation device based on accuracy required by the evaluation device.

20. The storage device of claim 19, wherein the parameter optimization circuit is configured to output the encryption parameter and the bootstrapping parameter in conjunction with each other based on one modular approximation polynomial operation depth selected in the range of modular approximation polynomial operation depths.
